(19) United States
(12) Patent Application Publication
(10) Pub. No.: US 2010/0122593 A1
(43) Pub. Date: May 20, 2010

(54) Coupling for Driving Shaft and Driven Shaft

(75) Inventor: Chanseok JEONG, Seoul (KR)

Correspondence Address: MORGAN, LEWIS & BOCKIUS LLP (SF), One Market, Spear Street Tower, Suite 2800, San Francisco, CA, 94105, US

(73) Assignees: Kia Motors Corporation, Seoul (KR); Hyundai Motor Company, Seoul (KR)

(21) Appl. No.: 12/578,200

(22) Filed: Oct. 13, 2009

(30) Foreign Application Priority Data
Nov. 17, 2008 (KR) 10-2008-0113846

(51) Int. Cl. F16H 21/12

(52) U.S. Cl. 74/11

(57) ABSTRACT

A coupling for a driving shaft and a driven shaft may include a driving lever that extends in a radial direction from the driving shaft and being limited in rotation with respect to the driving shaft, a driven lever that extends in a radial direction from the driven shaft and being limited in rotation with respect to the driven shaft, and a connecting member that has two different rotational shafts spaced with a predetermined distance and pivotally coupled to one end portion of the driving lever and one end portion of the driven shaft respectively.

### CROSS-REFERENCE TO RELATED APPLICATIONS

The present application claims priority to Korean Application Serial Number 10-2008-0113846, filed on Nov. 17, 2008, the entire contents of which is incorporated herein for all purpose by this reference.

### BACKGROUND OF THE INVENTION

1. Field of the Invention

The present invention relates to a coupling for a driving shaft and a driven shaft, particularly a coupling that allows power to be smoothly and stably transmitted, even if a driving shaft and a driven shaft are eccentric.

2. Description of Related Art

A driving device, such as a motor, which transmits rotational force to a shaft is required to drive a valve that opens/closes a flow channel by rotation of the shaft.

Therefore, a coupling that transmits the rotational force generated from a rotary shaft (driving shaft) of the motor to a shaft (driven shaft) of the valve is needed between the motor, which is the driving device, and the valve, which is a driven device.

The coupling that connects the driving shaft with the driven shaft can be classified according to the arrangement of the driving shaft and the driven shaft. One of them is a coupling that is applied to a structure having a driving shaft and a driven shaft coaxially arranged in the axial direction in a series and another one is a coupling that is applied to a structure having a driving shaft and a driven shaft arranged in parallel with each other.

The first one is designed and manufactured such that the driving shaft and the driven shaft are coaxially disposed; however, it is difficult to substantially coaxially arrange them, and as the coaxial precision increases, the work becomes difficult and the cost rapidly increases.

According to the other one, a link member that is perpendicular to a driving shaft and the driven shaft is provided between the shafts as a coupling, or a gear or a belt may be disposed to transmit power, in which the problem relating to the coaxial precision as described above is basically prevented.

However, it is required to coaxially dispose a driving shaft and a driven shaft, as in the above first case, due to various installation environments and arrangement relationships of a variety of mechanical apparatuses. In particular, this is further required for the engine room of a vehicle, and a configuration composed of an EGR valve and a motor connected to driving the valve can be an exemplified.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a coupling for a driving shaft and a driven shaft that can compensate eccentricity that may be generated between the driving shaft and the driven shaft and transmit power stably and accurately, in a structure in which the driving shaft and the driven shaft are coaxially arranged.

In an aspect of the present invention, the coupling for a driving shaft and a driven shaft, may include a driving lever that extends in a radial direction from the driving shaft and being limited in rotation with respect to the driving shaft, a driven lever that extends in a radial direction from the driven shaft and being limited in rotation with respect to the driven shaft, and a connecting member, both end portions of which are spaced with a predetermined distance and pivotally coupled to one end portion of the driving lever and one end portion of the driven shaft respectively.

The connecting member may include two rotational shafts spaced apart with the predetermined distance in a plane perpendicular to rotational axes of the driving shaft and the driven shaft, and is pivotably connected to the driving lever and the driven lever via the two rotational shafts respectively, wherein the connecting member has circular fitting holes at the end portions thereof to form the rotational shafts, and wherein a driving-sided connecting pin forming one of the rotational shafts by being inserted in one of the fitting hole of the connecting member protrudes from the driving lever and a driven-sided connecting pin forming the other rotational shaft by being inserted in the other fitting hole of the connecting member protrudes from the driven lever.

The predetermined distance between the two rotational shafts of the connecting member may be set such that an included angle between the driving lever and the driven lever make an acute angle.

In another aspect of the present invention, the connecting member may be disposed in a flat plate shape between a pivot plane of the driving lever and a pivot plate of the driven lever.

In further another aspect of the present invention, the connecting member may have circular fitting holes at the both end portions thereof to form rotational shafts connected with the driving lever and the driven lever, wherein a driving-sided connecting pin forming one of the rotational shafts by being inserted in one of fitting holes of the connecting member protrudes from the driving lever and a driven-sided connecting pin forming the other rotational shaft by being inserted in the other fitting hole of the connecting member protrudes from the driven lever.

In another aspect of the present invention, the driving shaft is a rotary shaft of a motor and the driven shaft is a valve shaft of an EGR valve.

According to various aspects of the present invention, it is possible to compensate eccentricity that may be generated between a driving shaft and a driven shaft and transmit power stably and accurately, in a structure in which the driving shaft and the driven shaft are coaxially arranged.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a view illustrating the structure of a coupling for a driving shaft and a driven shaft according to an exemplary embodiment of the present invention.

FIG. 2 is an exploded perspective view of FIG. 1.

FIG. 3 is a view only showing the connecting structure of the driving link, the driven link, and the connecting member of FIG. 1.

FIG. 4 is a view illustrating the operation of the present invention.

FIG. 5 is a view comparing the operations when the shafts are eccentric and not eccentric in the up-down direction.

FIG. 6 is a view showing an EGR apparatus where the present invention is applied.

FIG. 7 is a view showing the main part of FIG. 6 in more detail.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

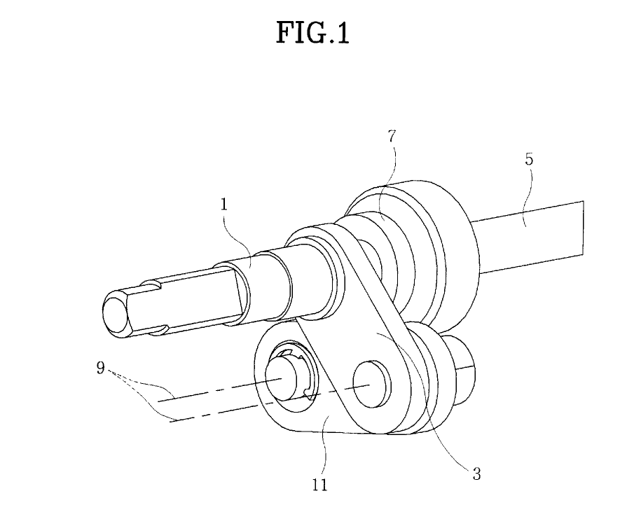

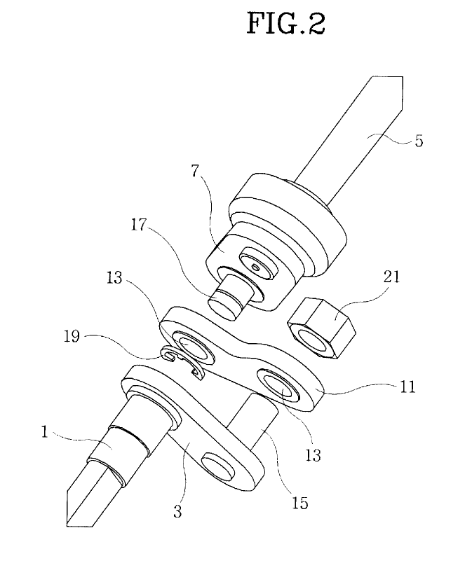

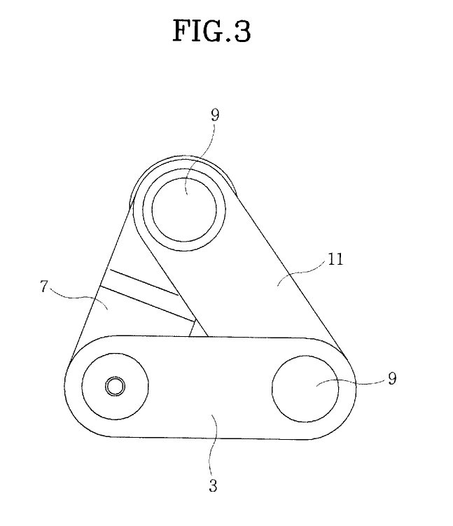

Referring to FIGS. 1 to 5, a coupling for a driving shaft and a driven shaft according to an exemplary embodiment of the present invention includes: a driving lever 3 that extends in the radial direction of a driving shaft 1 while being limited in rotation with respect to driving shaft 1; a driven lever 7 that extends in the radial direction of a driven shaft 5 while being limited in rotation with respect to driven shaft 5; and a connecting member 11 that has two different rotational shafts 9 spaced apart from driving shaft 1 and driven shaft 5, respectively, in a plane perpendicular to driving shaft 1 and driven shaft 5, and is pivotably connected to driving lever 3 and driven lever 7 by two rotational shafts 9.

Connecting member 11 is disposed in a flat plate shape between the pivot plane of driving lever 3 and the pivot plate of driven lever 7 and has circular fitting holes 13 to form rotational shafts 9 connected with driving lever 3 and driven lever 7, and is formed of a long flat plate member with both ends rounded in this embodiment.

A driving-sided connecting pin 15 forming rotational shaft 9 by being inserted in fitting hole 13 of connecting member 11 protrudes from driving lever 3 and a driven-sided connecting pin 17 forming rotational shaft 9 by being inserted in the other fitting hole 13 of connecting member 11 protrudes from driven lever 7.

Driving-sided connecting pin 15 is inserted in fitting hole 13 of connecting member 11 and then fixed by a nut 21 and driven-sided connecting pin 17 is inserted in fitting hole 13 of connecting member 11 and then fixed by a snap ring 19.

Alternatively, snap ring 19 and nut 21 may be used selectively or together with for any one of driving-sided connecting pin 15 and driven-sided connecting pin 17.

It is preferable to set the distance between two rotational shafts 9 of connecting member 11 such that driving lever 3 and driven lever 7 make an acute angle, which is about around 60° in this embodiment such that connecting member 11, driving lever 3, and driven lever 7 substantially make a regular triangle.

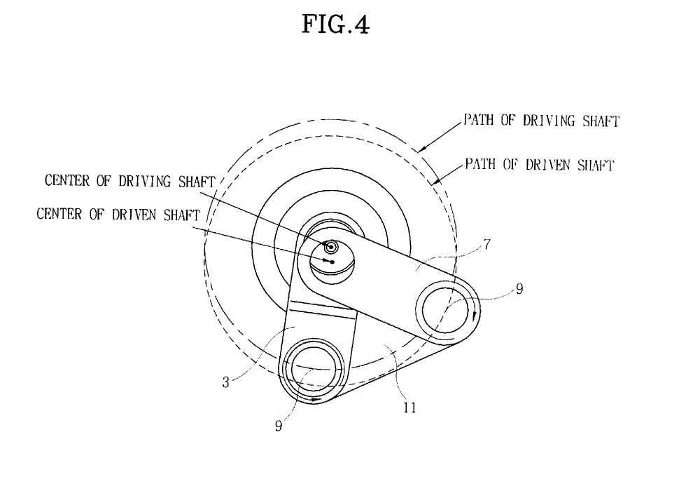

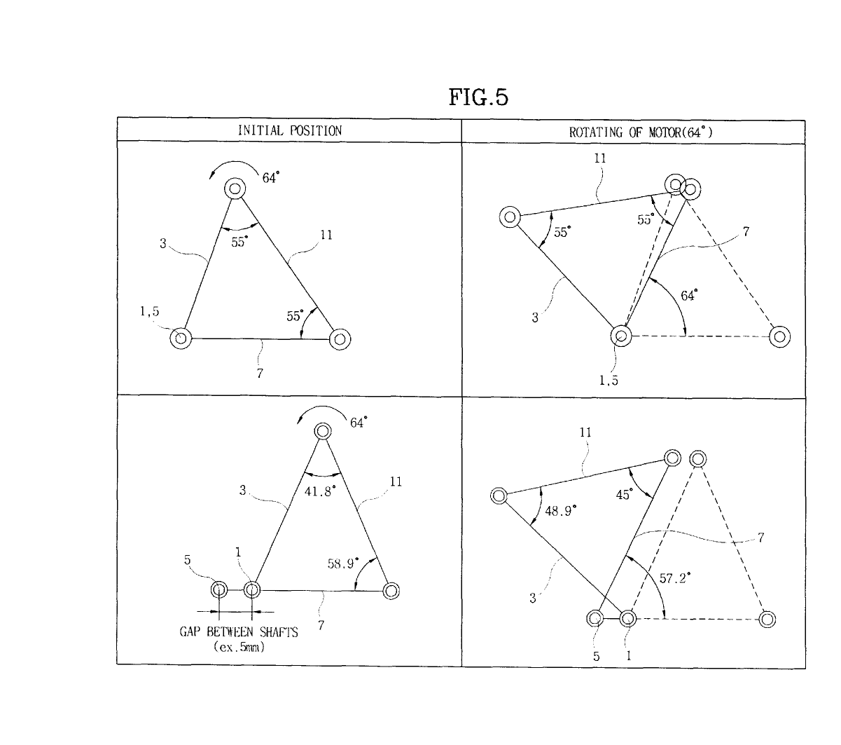

The principle and operation of compensating eccentricity between driving shaft 1 and driven shaft 5 of the coupling for driving shaft 1 and driven shaft 5 having the above configuration is described with reference to FIGS. 4 and 5.

In FIG. 4, the rotational path of driving-sided connecting pin 15 by rotation of driving shaft 1 and the rotational path of driven-sided connecting pin 17 by rotation of driven shaft 5 cross each other, as shown in the figure.

This is because driving shaft 1 and driven shaft 5 became eccentric due to a machining error or an assembly error, even though they had been coaxially disposed, and the rotation of driving shaft 1 and driven shaft 5 is compensated by connecting member 11.

That is, as driving shaft 1 rotate, relative rotation is generated between the fitting hole and driving-sided connecting pin 15, and the fitting hole and driven-sided connecting pin 17, centering around rotational shaft 9 formed at both sides of connecting member 11, thereby compensating the eccentricity of driving shaft 1 and driven shaft 5.

FIG. 5 illustrates the principle of compensating eccentricity in more detail using a specific example, in which an ideal case of driving shaft 1 and driven shaft 5 coaxially arranged is shown at the upper portion and the position when driving lever 3 has rotated at 64° from the initial position shown at the right side is shown in the left side. The angles between connecting member 11, driving lever 3, and driven lever 7 are maintained at 55° before and after driving shaft 1 rotates and driven lever 7 also rotates at 64°.

At the lower portion, it is shown that driving shaft 1 and driven shaft 5 are not accurately coaxially disposed and non-coaxially disposed with a gap of about 5 mm, for comparison as in the upper portion. Comparing when driving lever 3 has rotated at 64° at the right side with respect to the initial position at the right side, it can be seen that the angles between connecting member 11 and driving lever 3 and between connecting member 11 and driven lever 7 are changed and the rotational angle of driven lever 7 is 57.2°, different from driving lever 3.

That is, when driving shaft 1 and driven shaft 5 are non-coaxially disposed, by using the coupling according to an exemplary embodiment of the present invention, a four-bar link including driving lever 3, driven lever 7, and connecting member 11 is implemented by adding another link member between driving shaft 1 and driven shaft 5, such that power is transmitted while the eccentricity of driving shaft 1 and driven shaft 5 is compensated by changing the angles between the link members.

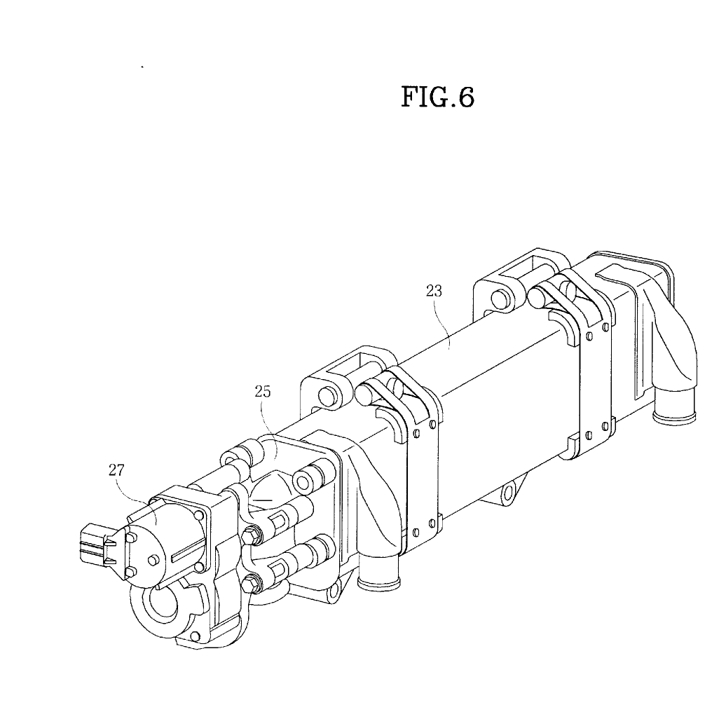

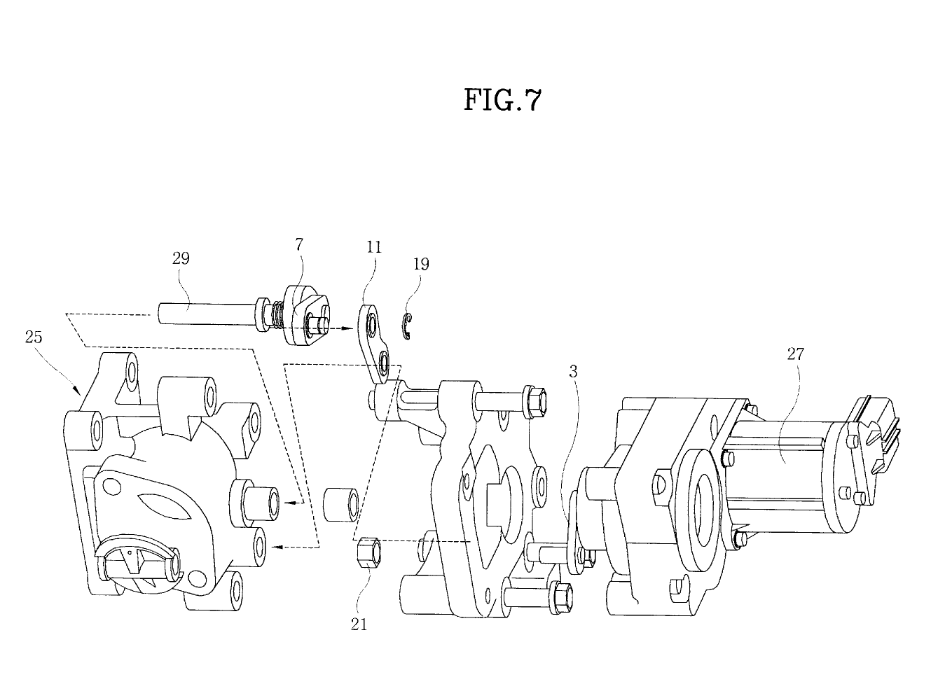

The coupling for driving shaft 1 and driven shaft 5 having the above configuration and operating as described above can be applied to an EGR valve of a vehicle and disposed to drive an EGR valve 25 connected to an EGR cooler 23 using a motor 27 as shown in FIGS. 6 and 7, in which EGR cooler 23, EGR valve 25, and motor 27 are arranged on a straight line.

For reference, in FIGS. 6 and 7, a rotary shaft of motor 27 is not directly connected to a valve shaft 29 of EGR valve 25 to adjust rotational velocity and torque such that power is transmitted through an intermediate shaft; however, rotary shaft of motor 27 may be disposed at the position of the intermediate shaft to be directly connected to valve shaft 29.

When EGR cooler 23, EGR valve 25, and motor 27 are arranged on a straight line as described above, it is possible to ensure advantageous mechanical properties in vibration and rigidity, as compared with a structure in which motor 27 protrudes from a side of EGR valve 25.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A coupling for a driving shaft and a driven shaft, comprising:
a driving lever that extends in a radial direction from the driving shaft and being limited in rotation with respect to the driving shaft;
a driven lever that extends in a radial direction from the driven shaft and being limited in rotation with respect to the driven shaft; and
a connecting member, both end portions of which are spaced with a predetermined distance and pivotally coupled to one end portion of the driving lever and one end portion of the driven shaft respectively.

2. The coupling for a driving shaft and a driven shaft as defined in claim 1, wherein the connecting member includes two rotational shafts spaced apart with the predetermined distance in a plane perpendicular to rotational axes of the driving shaft and the driven shaft, and is pivotably connected to the driving lever and the driven lever via the two rotational shafts respectively.

3. The coupling for a driving shaft and a driven shaft as defined in claim 2, wherein the connecting member has circular fitting holes at the end portions thereof to form the rotational shafts.

4. The coupling for a driving shaft and a driven shaft as defined in claim 3, wherein a driving-sided connecting pin forming one of the rotational shafts by being inserted in one of the fitting hole of the connecting member protrudes from the driving lever and a driven-sided connecting pin forming the other rotational shaft by being inserted in the other fitting hole of the connecting member protrudes from the driven lever.

5. The coupling for a driving shaft and a driven shaft as defined in claim 2, wherein the predetermined distance between the two rotational shafts of the connecting member is set such that an included angle between the driving lever and the driven lever make an acute angle.

6. The coupling for a driving shaft and a driven shaft as defined in claim 1, wherein the connecting member is disposed in a flat plate shape between a pivot plane of the driving lever and a pivot plate of the driven lever.

7. The coupling for a driving shaft and a driven shaft as defined in claim 1, wherein the connecting member has circular fitting holes at the both end portions thereof to form rotational shafts connected with the driving lever and the driven lever.

8. The coupling for a driving shaft and a driven shaft as defined in claim 7, wherein a driving-sided connecting pin forming one of the rotational shafts by being inserted in one of fitting holes of the connecting member protrudes from the driving lever and a driven-sided connecting pin forming the other rotational shaft by being inserted in the other fitting hole of the connecting member protrudes from the driven lever.

9. The coupling for a driving shaft and a driven shaft as defined in claim 1, wherein the driving shaft is a rotary shaft of a motor and the driven shaft is a valve shaft of an EGR valve.
